(19) United States
(12) Patent Application Publication
(10) Pub. No.: US 2017/0246548 A1
(43) Pub. Date: Aug. 31, 2017

(54) SOUNDING PET TOY

(71) Applicant: TONGFU MANUFACTURING CO., LTD., Nanjing (CN)

(72) Inventor: Wen ZHANG, Nanjing (CN)

(73) Assignee: TONGFU MANUFACTURING CO., LTD., Nanjing (CN)

(21) Appl. No.: 15/146,309

(22) Filed: May 4, 2016

(30) Foreign Application Priority Data
Feb. 26, 2016 (CN) 201620142697.0

(51) Int. Cl. A63H 3/31; A01K 15/02

(52) U.S. Cl. CPC A63H 3/31; A01K 15/025

(57) ABSTRACT

A sounding pet includes a plush toy skin, toy liner and sounding device, where the toy liner is a hollow flexible cylinder, the plush toy skin wraps the toy liner, and sounding device is in the toy liner; the sounding device is serially connecting and tightly matching plurality of plastic joints; each plastic joint includes a horn body and clamping body which are integrally formed, adjacent plastic joints are tightly matched by clamping bodies and horn bodies, the clamping bodies and horn bodies are matched, the clamping body of the former plastic joint is clamped in the horn body of the latter plastic joint, and airflow channel is formed in the matched clamping and horn bodies. When the pet plays the toy, the sounding device in the toy liner is extruded; the tightly matched plastic joints are bent and rub against each other generating a sound, attracting the pet.

### TECHNICAL FIELD

The present utility model belongs to the technical field of toys, and particularly relates to a sounding pet toy.

### BACKGROUND

Along with a growth in the living standard, people like pets more and more, and requirements on a pet toy are also higher and higher, in order to attract an interest of the pet, the pet toy is usually designed into various modeling structures to attract the pet to play, however, most of the existing toy pets do not have a sounding function which easily enables the pet to lose a playing interest, in order to overcome such defect, a calling element for sounding is arranged in some pet toys, but this kind of sounding elements need to have a enough sounding space and is inconvenient to mount.

### SUMMARY

The present utility model aims to overcome defects of the prior art, and provides a sounding pet toy, the toy can attract a pet to play for a long time, and when the pet bites the toy, the toy emits a sound, thus improving a playing interest of the pet.

The sounding pet comprises a plush toy skin, a toy liner and a sounding device, wherein the toy liner is a hollow flexible cylinder, the plush toy skin wraps the toy liner, and the sounding device is arranged in the toy liner; the sounding device is formed by serially connecting and tightly matching a plurality of plastic joints; each plastic joint includes a horn body and a clamping body which are integrally formed, adjacent plastic joints are tightly matched by the clamping bodies and the horn bodies, the clamping bodies and the horn bodies are matched, the clamping body of the former plastic joint is clamped in the horn body of the latter plastic joint, and an airflow channel is formed in the matched clamping bodies and horn bodies.

Since the sounding device is formed by serially connecting and tightly matching a plurality of plastic joints, when the pet plays the toy and bites the toy, the sounding device is bent, the tightly matched plastic joints emit a sound due to friction, and the emitted sound is transmitted out by the airflow channel to attract the pet to play. The plastic joints are made of POM.

It should be specified that the toy liner is made of a flexible material, and when the pet bites the flexible material, the toy liner is easy to deform, so that the sounding device in the toy liner is bent.

Preferably, the toy liner is a cylindrical foaming body. The toy liner is formed by foaming of a foaming material, which can be EVA, TPR, rubber or other flexible materials.

The toy can have a plurality of modelings, and the disclosed is a caterpillar modeling of the plush toy skin.

The present utility model has the beneficial effects that according to the sounding toy provided according to the present utility model, when the pet plays the toy, the sounding device in the toy liner is extruded, the tightly matched plastic joints are bent and rub against each other to generate a sound, the pet is attracted to play for a long time and a playing interest of the pet is improved.

### BRIEF DESCRIPTION OF THE DRAWINGS

FIG. 1 is a separated structural schematic diagram of the present utility model.

FIG. 2 is a sectional view of the present utility model.

FIG. 3 is a structural schematic diagram of two adjacent plastic joints in a sounding device of the present utility model.

FIG. 4 is a separated structural schematic diagram of a sounding device of the present utility model.

Marks description of the drawings: 1, plush toy skin, 2, toy liner, 3, sounding device, 3.1, plastic joint, 3.11, horn body, 3.12, clamping body, 3.13, airflow channel

### DETAILED DESCRIPTION

The present utility model is further described in combination with drawings and a specific embodiment.

### Embodiment

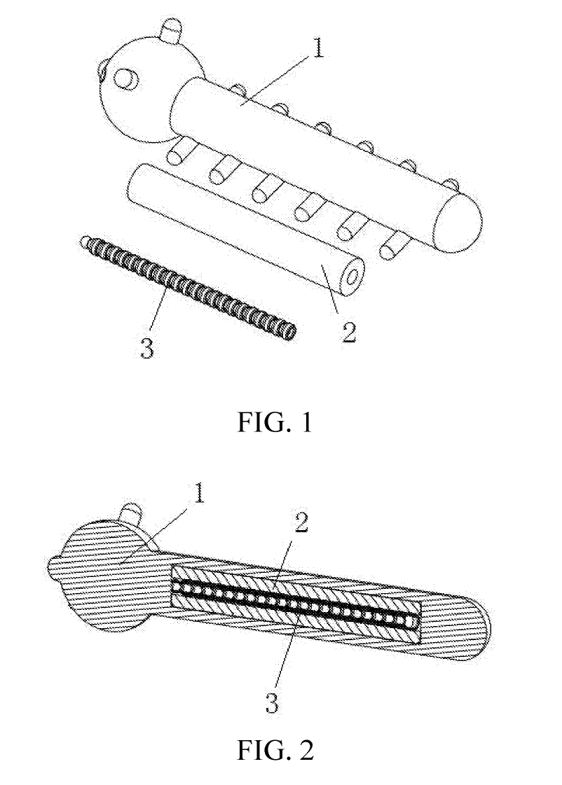

A sounding toy as shown in FIG. 1 and FIG. 2 comprises a plush toy skin 1, a toy liner 2 and a sounding device 3, the toy can have a plurality of modelings, the present embodiment provides a caterpillar modeling toy, the toy liner 2 is a hollow flexible cylinder, the plush toy skin 1 wraps the toy liner 2, and the sounding device 3 is arranged in the toy liner 2; and the toy liner 2 is a cylindrical foaming body. The toy liner 2 is formed by foaming of a foaming material, which can be EVA, TPR, rubber or other flexible materials. When a pet bites the flexible material, the toy liner 2 is easy to deform, so that the sounding device 3 in the toy liner is 2 bent.

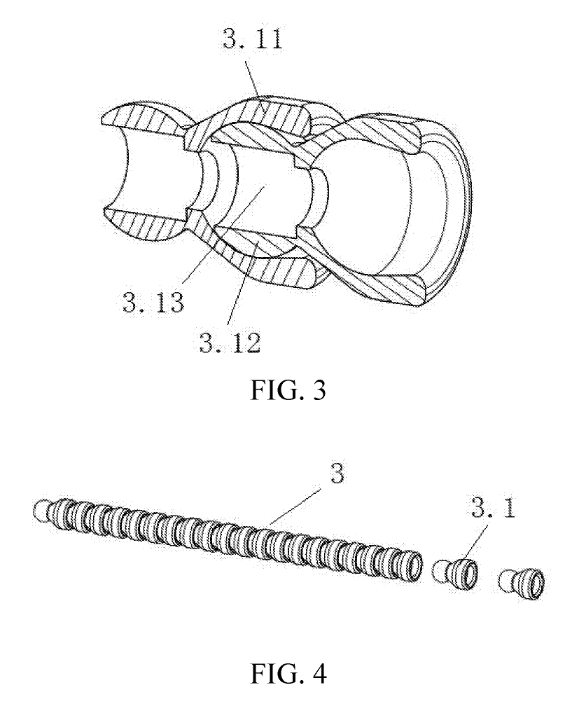

As shown in FIG. 3 and FIG. 4, the sounding device 3 is formed by serially connecting and tightly matching a plurality of plastic joints 3.1; each plastic joint 3.1 includes a horn body 3.11 and a clamping body 3.12 which are integrally formed, adjacent plastic joints 3.1 are tightly matched by the clamping bodies 3.12 and the horn bodies 3.11, the clamping bodies 3.12 and the horn bodies 3.11 are matched, the clamping body of the former plastic joint is clamped in the horn body of the latter plastic joint, and an airflow channel 3.13 is formed in the matched clamping bodies and horn bodies.

Since the sounding device 3 is formed by serially connecting and tightly matching a plurality of plastic joints 3.1, when the pet plays the toy and bites the toy, the sounding device 3 is bent, the tightly matched plastic joints 3.1 rub against each other and generate resonance, and the sound emitted by friction is transmitted out by the airflow channel 3.13 to attract the pet to play.

According to the sounding toy provided according to the present utility model, when the pet plays the toy, the sounding device in the toy liner is extruded, the tightly matched plastic joints are bent and rub against each other to generate a sound, the pet is attracted to play for a long time and a playing interest of the pet is improved.

The above is merely examples of the present utility model and not limitative to the present utility mode, and all designs same or similar to the present utility model falls within a protective scope of the present utility mode.

1. A sounding pet toy comprising a plush toy skin, a toy liner and a sounding device, wherein the toy liner is a hollow flexible cylinder, the plush toy skin wraps the toy liner, and the sounding device is arranged in the toy liner; the sounding device is formed by serially connecting and tightly matching a plurality of plastic joints; each plastic joint includes a horn body and a clamping body which are integrally formed, adjacent plastic joints are tightly matched by the clamping bodies and the horn bodies, the clamping bodies and the horn bodies are matched, the clamping body of the former plastic joint is clamped in the horn body of the latter plastic joint, and an airflow channel is formed in the matched clamping bodies and horn bodies.

2. The sounding toy according to claim 1, wherein the toy liner is a cylindrical foaming body.
